(19) United States
(12) Patent Application Publication
(10) Pub. No.: US 2003/0002403 A1
(43) Pub. Date: Jan. 2, 2003

(54) Bandwidth control circuit and method for track-crossing signals used in optical storage drive

(76) Inventor: Yi-Chung Chan, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,207

(22) Filed: Mar. 28, 2002

(30) Foreign Application Priority Data
Jun. 28, 2001 (TW) 090115843

(51) Int. Cl. G11B 7/085

(52) U.S. Cl. 369/44.28; 369/30.13; 369/30.17

(57) ABSTRACT

A bandwidth control circuit and method for track-crossing signals used in an optical storage drive is used to generate a second track-crossing signal according to a first track-crossing signal transmitted from an pick-up device of the optical storage drive. The bandwidth control circuit has a first and a second low pass filters for filtering noise of the first track-crossing signal, and a track-crossing velocity calculation device for calculating a frequency of the second track-crossing signal. When the frequency of the second track-crossing signal is higher than a predetermined value, the first low pass filter is used to filter the noise of the first track-crossing signal. Otherwise, the second low pass filter is used to filter the noise of the first track-crossing signal. The method dynamically switches the low pass filters according to the frequencies of the track-crossing signals.

### BACKGROUND OF INVENTION

1. Field of the Invention

The invention relates to a bandwidth control circuit for track-crossing signals used in an optical storage drive, and more particularly, to a bandwidth control circuit having a track-crossing velocity calculation device for dynamically selecting a filter device. The bandwidth control circuit of the present invention can be used to select the filter devices with different bandwidths corresponding to each of the track-crossing signals with different velocities (frequencies).

2. Description of the Prior Art

In modern society, there has been a spread in the use of optical storage medium, such as compact discs, for recording a huge amount of high-density digital information. The optical storage media have advantages of lightweight, small size, and large capacity for data storage. Meanwhile, a reproducing apparatus, referred to as an optical storage drive, is indispensable for reading out the information stored on the optical storage medium. In order to allow the optical storage drive to read high-density data rapidly, it is necessary to precisely read the recorded information on the optical storage medium. Therefore, developing a precise control system for the optical storage drive with a high access speed has become an important topic of the information industry.

Typically, the optical storage medium can be divided along a radial direction into a plurality of tracks on which data is stored. When the optical storage drive reads data stored in the tracks on the optical storage medium, a pickup device of the optical storage drive is moved along the radial direction of the optical storage carrier back and forth. Meanwhile, if data to be read is stored in a position that locates at a finite number of tracks apart from the current position of the pickup device, the pickup device has to perform a long and then short distance track-crossing processes so as to reach the target track. In the long distance track-crossing process, a track-crossing velocity (or a track-crossing frequency) of the pink-up device is accelerated from a lower velocity (or a lower frequency) to a higher velocity (or a higher frequency). Then, when approaching the target track, the pick-up device is decelerated by a brake mechanism so that the pick-up device can be positioned in a vicinity of the target track. Thereafter, the pick-up device is moved precisely to the target track of the optical storage medium during the short distance track-crossing process so as to read data in the target track.

Furthermore, when the optical storage drive reads data in the optical storage medium, a chipset in the optical storage drive receives a track-crossing signal, which is generally a radio frequency (RF) signal transmitted from the pick-up device of the optical storage drive. After the track-crossing signal is held at peak, the track-crossing signal is filtered by a low pass filter which has a specific bandwidth so as to filter out high-frequency noise that has a great influence on the signal to noise ratio (SNR) of the track-crossing signal. When the bandwidth of the low pass filter is too wide, the high-frequency noise cannot be filtered out and the SNR of the track-crossing signal is thus reduced.

Generally, the prior chipset manufacturer sets the bandwidth of the above-mentioned low pass filter around 200 KHz. The low pass filter with such bandwidth can thus merely deal with the track-crossing signal at 200 KHz, i.e., the condition of crossing 200,000 tracks of the optical storage medium within one second. However, for a high-speed optical storage drive, the speed of the long distance track-crossing process is much faster, and the frequency of the corresponding track-crossing signal is thus higher. Consequently, the higher frequency of the track-crossing signal is filtered out inappropriately due to the narrow bandwidth of the low pass filter. This situation is more serious if the number of tracks on the optical storage medium is increased. For example, the number of tracks on a digital versatile disc (DVD) is twice as many as the number of tracks on a compact disc (CD). Additionally, since the bandwidth of the prior low pass filter is too narrow, the prior low pass filter can only deal with the track-crossing signals that have low frequencies. Under this condition, for achieving the purpose of reading data accurately, the chipset manufacturer usually utilizes an optical grating to calculate the track-crossing velocity so as to meet the requirements of the long distance track-crossing process. However, the installation of the optical grating further increases the cost of the optical storage drive.

### SUMMARY OF INVENTION

It is therefore a primary objective of the claimed invention to provide a bandwidth control circuit and method for track-crossing signals used in an optical storage drive to solve the above-mentioned problem.

According to the claimed invention, a bandwidth control circuit for track-crossing signals used in an optical storage drive is used for generating a second track-crossing signal according to a first track-crossing signal transmitted from an pick-up device of the optical storage drive. The bandwidth control circuit comprises an input end for receiving the first track-crossing signal, an output end for outputting the second track-crossing signal, a filter device electrically connected to the input end and the output end for filtering noise of the first track-crossing signal so as to generate the second track-crossing signal, a track-crossing velocity calculation device electrically connected to the output end for calculating a frequency of the second track-crossing signal and then generating a calculation result, and a filter selection device electrically connected to the track-crossing velocity calculation device for controlling the filter device according to the calculation result. The filtering device further comprises at least a first low pass filter and a second low pass filter, and each of the low pass filters has different bandwidths. When the frequency of the second track-crossing signal calculated by the track-crossing velocity calculation device is higher than a predetermined value, the filter selection device controls the filter device to filter the noise of the first track-crossing signal via the first low pass filter. Conversely, when the frequency of the second track-crossing signal calculated by the track-crossing velocity calculation device is lower than the predetermined value, the filter selection device controls the filter device to filter the noise of the first track-crossing signal via the second low pass filter.

It is an advantage of the claimed invention that the bandwidth control circuit and method are capable of dynamically switching the low pass filters with different bandwidths according to the different frequencies of the track-crossing signals of the optical storage drive. The bandwidth control circuit and method of the present invention not only can deal with the track-crossing signal with a high speed and a high frequency, but also can maintain the SNR of the track-crossing signal. Consequently, the performance of reading data on the optical storage carrier for the optical storage drive can be substantially improved.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

Unknown; Monica; FIG. 1 is a function block diagram of a bandwidth control circuit for track-crossing signals according to the present invention.

FIG. 2 is a flow chart of a bandwidth control method for track-crossing signals according to the present invention.

FIG. 3 is a schematic diagram illustrating frequency variations of a track-crossing signal during a long distance track-crossing process.

### DETAILED DESCRIPTION

Please refer to FIG. 1. FIG. 1 is a function block diagram of a bandwidth control circuit 50 for track-crossing signals according to the present invention. The bandwidth control circuit 50 is used to generate a second track-crossing signal 54 according to a first track-crossing signal 52 transmitted from a pick-up device of an optical storage drive. The first track-crossing signal 52 is a radio frequency (RF) signal, such as a tracking error (TE) signal, a tracking error signal zero crossing (TEZC), or any RF signals for the pick-up device during reading binary data stored on an optical storage medium, e.g., RFRP, DPD, RFZC, and the like.

The bandwidth control circuit 50 comprises an input end 53 for receiving the first track-crossing signal 52, an output end 55 for outputting the second track-crossing signal 54, a filter device 56 electrically connected to the input end 53 and the output end 55 for filtering high-frequency noise of the first track-crossing signal 52 so as to generate the second track-crossing signal 54, a track-crossing velocity calculation device 61 electrically connected to the output end 55 for calculating a frequency of the second track-crossing signal 54 and then generating a calculation result R, and a filter selection device 62 electrically connected to the track-crossing velocity calculation device 61 for controlling the filter device 56 according to the calculation result R and the frequency of the second track-crossing signal 54 calculated by the track-crossing velocity calculation device 61.

The filter device 56 can comprise more than two low pass filters, and the filter device 56 comprising three low pass filters with different bandwidths 57, 58, and 59 shown in FIG. 1 is only an embodiment of the present invention. According to the embodiment, the filtering device 56 has a first low pass filter 57, a second low pass filter 58, and a third low pass filter 59. The three low pass filters 57, 58, and 59 have different bandwidths of 100 KHz, 250 KHz, and 500 KHz, respectively. Moreover, the filter selection device 62 of the present invention may be a programmable multiplexer.

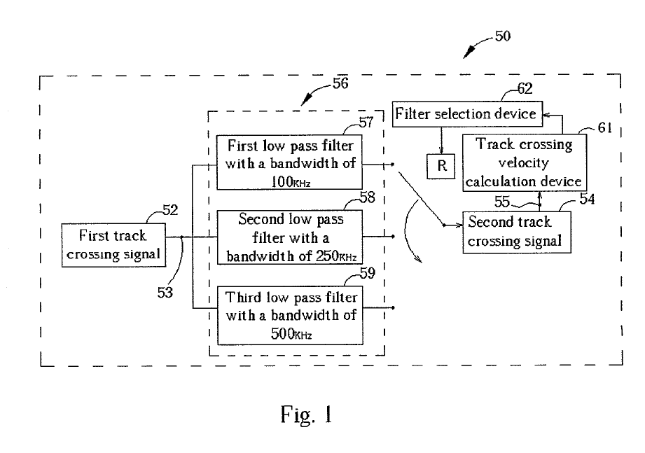

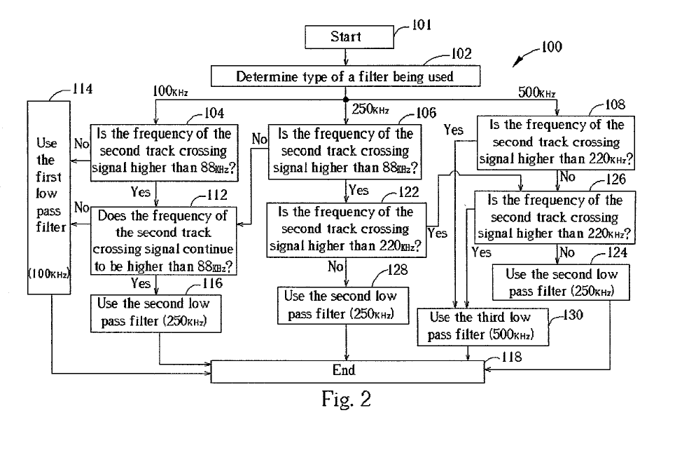

Please refer to FIG. 2. FIG. 2 is a flow chart of a bandwidth control method 100 used by the bandwidth control circuit 50 according to the present invention. Please refer to FIGS. 1 and 2. The bandwidth control method 100 of the present invention comprises the following steps:

Step 101: The flow starts.

Step 102:

The type of a filter being used is determined. The preferred embodiment provides the first low pass filter 57 with the bandwidth of 100 KHz, the second low pass filter 58 with the bandwidth of 250 KHz, and the third low pass filter 59 with the bandwidth of 500 KHz. If the filter being used is the first low pass filter 57, the flow goes to step 104. If the filter being used is the second low pass filter 58, the flow goes to step 106. If the filter being used is the third low pass filter 59, the flow goes to step 108.

Step 104:

If the frequency of the second track-crossing signal 54 is higher than a critical frequency (for example, 88 KHz), which is set by a circuit designer, the flow goes to step 112. If not, the flow goes to step 114 to continue using the first low pass filter 57 with the bandwidth of 100 KHz.

Step 106:

If the frequency of the second track-crossing signal 54 is higher than the critical frequency of 88 KHz, which is set by the circuit designer, the flow goes to step 122. If not, the flow goes to step 112 to calculate the frequency of the second track-crossing signal 54 again.

Step 108:

If the frequency of the second track-crossing signal 54 is higher than another critical frequency of 220 KHz, which is also set by the circuit designer, the flow goes to step 130. If not, the flow goes to step 126.

Step 112:

If the frequency of the second track-crossing signal 54 continues to be higher than the critical frequency of 88 KHz, the flow goes to step 116 for using the second low pass filter 58 with the bandwidth of 250 KHz instead of using the first low pass filter 57. If not, the flow goes to step 114 to continue using the first low pass filter 57 with the bandwidth of 100 KHz.

Step 114:

The first low pass filter 57 is used.

Step 116:

The second low pass filter 58 is used.

Step 118:

After it is determined to use which one of the three low pass filters 57, 58, and 59, the procedure of the bandwidth control method is ended, and then another cycle of the procedure is performed at the next trigger of the optical storage drive.

Step 122:

If the frequency of the second track-crossing signal 54 is higher than the another critical frequency of 220 KHz, the flow goes to step 126. If not, the flow goes to step 128.

Step 124:

The second low pass filter 58 is used.

Step 126:

If the frequency of the second track-crossing signal 54 is higher than the another critical frequency of 220 KHz, the flow goes to step 130. If not, the flow goes to step 124.

Step 128: The second low pass filter 58 is used.

Step 130: The third low pass filter 59 is used.

When the pick-up device of the optical storage drive starts to carry out the track-crossing process, the first and second track-crossing signals 52, 54 are accelerated from a lower velocity (or a lower frequency) to a higher velocity (or a higher frequency), which is determined by a distance between the initial position and the target position of the pick-up device. When the distance is longer, the velocity (or the frequency) required by the pick-up device is greater, and vice versa.

As shown in FIG. 2, the bandwidth control method of the present invention determines the type of the filter being used in step 102. Meanwhile, several types of the filters set previously are provided for selection. in the preferred embodiment of the present invention, the first low pass filter 57 with the bandwidth of 100 KHz, the second low pass filter 58 with the bandwidth of 250 KHz, and the third low pass filter 59 with the bandwidth of 500 KHz are provided. As shown in step 104, if the frequency of the second track-crossing signal 54 is higher than the critical frequency of 88 KHz, then the flow goes to step 112, otherwise, the flow goes to step 114 to continue using the first low pass filter 57 with the bandwidth of 100 KHz. That is, the pick-up device merely requires a filter with a lower bandwidth. Thereafter, in step 112, if the frequency of the second track-crossing signal 54 continues to be higher than the critical frequency of 88 KHz, then the flow goes to step 116 for using the second low pass filter 58 with the bandwidth of 250 KHz instead of using the first low pass filter 57. If not, the flow goes to step 114 to continue using the first low pass filter 57 with the bandwidth of 100 KHz.

On the other hand, when in the step 102, it is determined the filter being used is the second low pass filter 58 with the bandwidth of 250 KHz, then the procedure goes to step 106 to calculate the frequency of the second track-crossing signal 54. In the step 106, if the frequency of the second track-crossing signal 54 is not higher than the critical frequency of 88 KHz, then the flow goes to the step 112. Otherwise, the procedure goes to the step 122 to calculate the frequency of the second track-crossing signal 54 again. In the step 122, if the frequency of the second track-crossing signal 54 is lower than the another critical frequency of 220 KHz, then the flow goes to the step 128 to continue using the second low pass filter 58 with the bandwidth of 250 KHz. Otherwise, the procedure goes to the step 126 to calculate the frequency of the second track-crossing signal 54 again.

Finally, when in the step 102, it is determined the filter being used is the third low pass filter 59 with the bandwidth of 500 KHz, then the procedure goes to the step 108 to calculate the frequency of the second track-crossing signal 54. If the frequency of the second track-crossing signal 54 is higher than the critical frequency of 220 KHz, then the flow goes to the step 130 to continue using the third low pass filter 59 with the bandwidth of 500 KHz. Otherwise, the procedure goes to the step 126. In the step 126, if the frequency of the second track-crossing signal 54 is higher than the critical frequency of 220 KHz, then the flow goes to the step 130 to continue using the third low pass filter 59 with the bandwidth of 500 KHz. If not, then the flow goes to the step 124 for using the second low pass filter 58 with the bandwidth of 250 KHz instead of using the third low pass filter 59. After the steps 114, 116, 124, 128, and 130 are completed and which of the three low pass filters 57, 58, and 59 to be used is determined, the procedure of the bandwidth control method ends in the step 118. Then, another procedure of the bandwidth control method 100 is restarted at the next trigger of the optical storage drive within a predetermined time interval, which is determined by a circuit designer.

In the bandwidth control method 100 of the present invention, the steps 112, 122, and 126 are used not only to adapt to the variations of the track-crossing velocity, but also to ensure the accuracy of the frequency of the second track-crossing signal 54. Since the track-crossing signals may be affected by glitches or other unexpected noise, the steps 112, 122, and 126 can be performed repeatedly so as to confirm the suitability of the filter. In the actual circuit design, a register may be used to store a value for comparison. When a frequency of a track-crossing signal is higher than a predetermined value, the register automatically adds the value of one to the value. Then, when the value stored in the register is greater than a default value set previously, the frequency of the track-crossing signal can thus be ensured so that the procedure can proceed to the next step. Meanwhile, the value in the register is reset so as to be used in the next trigger of the optical storage drive within a predetermined time interval. Additionally, the method for calculating the frequency of the second track-crossing signal 54 includes providing a pulse signal with a predetermined period, then calculating a number of second track-crossing signals 54 within one period of the pulse signal. Incidentally, each of the low pass filters 57, 58, and 59 has different bandwidths, and these bandwidths and the critical frequency smaller than the bandwidths of the low pass filters 57, 58, and 59, are all determined by a circuit designer for meeting requirements.

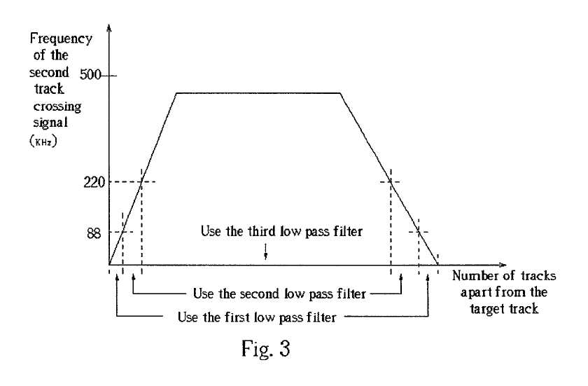

Please refer to FIG. 3. FIG. 3 is a schematic diagram illustrating frequency variations of the second track-crossing signal 54 during a long distance track-crossing process. When the pick-up device performs the long distance track-crossing process, the pick-up device is accelerated from a static state to a permitted higher velocity. Then, when approaching the target track, the pick-up device is decelerated by a brake mechanism so that the pick-up device can position in the vicinity of the target track. Thereafter, the pick-up device is moved precisely to the target track of the optical storage medium during a short distance track-crossing process so as to read data in the target track.

As shown in FIG. 3, when the frequency of the second track-crossing signal 54 is gradually increased to a first critical frequency, such as 88 KHz in the preferred embodiment of the present invention, the filter selection device 62 controls the filter device 56 to use the second low pass filter 58, and when the frequency of the second track-crossing signal 54 is lower than the first critical frequency, the filter selection device 62 controls the filter device 56 to continue using the first low pass filter 57. Then, when the frequency of the second track-crossing signal 54 is increased to a second critical frequency, such as 220 KHz in the preferred embodiment of the present invention, the filter selection device 62 controls the filter device 56 to use the third low pass filter 59 with the bandwidth of 500 KHz. Likewise, when the frequency of the second track-crossing signal 54 is lower than the second critical frequency, the filter selection device 62 controls the filter device 56 to continue using the first low pass filter 57 or the second low pass filter 58. After the frequency of the second track-crossing signal 54 exceeds the second critical frequency, a restriction is imposed on the track-crossing velocity so that the track-crossing velocity has an upper limit of a default value which equals to the bandwidth of the third low pass filter 59. Therefore, the filter device 62 continues using the third low pass filter 59 and the frequency of the second track-crossing signal 54 is maintained for a period until the number of tracks apart from the target track is below a predetermined value. When approaching the target track, the pick-up device is decelerated and the filter is switched according to the range of the frequency of the second track-crossing signal 54 in the same manner as the above-mentioned acceleration procedure. According to the procedures described previously, the optical storage drive of the present invention can thus achieve the purpose of dynamically switching the filters.

In contrast to the prior art, the bandwidth control circuit and method according to the present invention is capable of dynamically switching filters with different bandwidths according to a calculated frequency of a track-crossing signal. According to the present invention, the optical storage drive can not only deal with a track-crossing signal with a high frequency, but also can prevent the alteration of a signal to noise ratio. Furthermore, the optical storage drive of the present invention does not require gratings to compensate a high speed of a long distance track-crossing process, and the cost of the optical storage drive can thus be substantially reduced. Consequently, the optical storage drive with the bandwidth control circuit of the present invention can have high-speed performance through the switching of filters, and eliminates the potential problem for mechanical breakdowns of the gratings. Incidentally, the present invention is especially suitable for use in the mass production of application specific integrated circuits (ASIC).

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A bandwidth control circuit for track-crossing signals used in an optical storage drive for generating a second track-crossing signal according to a first track-crossing signal transmitted from an pick-up device of the optical storage drive, the bandwidth control circuit comprising:
a filter device, for filtering the first track-crossing signal so as to generate the second track-crossing signal, the filtering device comprising at least a first low pass filter and a second low pass filter, each of the low pass filters having different bandwidths;
a track-crossing velocity calculation device, for calculating a frequency of the second track-crossing signal and then generating a calculation result; and
a filter selection device electrically connected to the track-crossing velocity calculation device for controlling the filter device according to the calculation result;
wherein when the frequency of the second track-crossing signal calculated by the track-crossing velocity calculation device is higher than a predetermined value, the filter selection device controls the filter device to filter the first track-crossing signal via the first low pass filter, or when the frequency of the second track-crossing signal calculated by the track-crossing velocity calculation device is lower than the predetermined value, the filter selection device controls the filter device to filter the first track-crossing signal via the second low pass filter.

2. The bandwidth control circuit of claim 1, wherein when the frequency of the second track-crossing signal calculated by the track-crossing velocity calculation device is higher than the predetermined value, the filter selection device controls the first low pass filter to transfer the first track-crossing signal to the second track-crossing signal for outputting, or when the frequency of the second track-crossing signal calculated by the track-crossing velocity calculation device is lower than the predetermined value, the filter selection device controls the second low pass filter to transfer the first track-crossing signal to the second track-crossing signal for outputting.

3. The bandwidth control circuit of claim 1, wherein the filter selection device is a programmable multiplexer.

4. The bandwidth control circuit of claim 1, wherein the track-crossing velocity calculation device determines the frequency of the second track-crossing signal according to a pulse signal with a predetermined period.

5. The bandwidth control circuit of claim 4, wherein the track-crossing velocity calculation device determines the frequency of the second track-crossing signal through calculating number of the second track-crossing signals within one period of the pulse signal.

6. A bandwidth control method for track-crossing signals used in an optical storage drive for dynamically switching a filter according to a frequency of a track-crossing signal of the optical storage drive, the filter being used to filter a first track-crossing signal transmitted from an pick-up device of the optical storage drive so as to generate a second track-crossing signal, the bandwidth control method comprising:
determining which filter being used;
setting at least one critical frequency for switching the filter;
calculating a frequency of the second track-crossing signal; and
switching the filter to another filter when the frequency of the second track-crossing signal is higher than the critical frequency, or continuing using the filter when the frequency of the second track-crossing signal is lower than the critical frequency.

7. The bandwidth control method of claim 6, wherein the step for calculating the frequency of the second track-crossing signal comprises:
providing a pulse signal with a predetermined period; and
calculating number of the second track-crossing signals within one period of the pulse signal so as to determine the frequency of the second track-crossing signal.

8. A bandwidth control method for track-crossing signals used in an optical storage drive for dynamically switching a filter according to a frequency of a track-crossing signal of the optical storage drive, the filter being used to filter a first track-crossing signal transmitted from an pick-up device of the optical storage drive so as to generate a second track-crossing signal, the bandwidth control method comprising:
setting a first low pass filter, a second low pass filter, and a third low pass filter, each of the low pass filters having different bandwidths, and setting critical frequencies corresponding to the first and second low pass filters for determining whether or not to continue using the filter;
determining whether the filter being used is the first, second, or third low pass filter;
switching the first low pass filter to the second low pass filter when the filter being used is the first low pass filter and the frequency of the second track-crossing signal continues to be higher than the critical frequency corresponding to the first low pass filter, otherwise continuing using the first low pass filter;
switching the second low pass filter to the third low pass filter when the filter being used is the second low pass filter and the frequency of the second track-crossing signal continues to be higher than the critical frequency corresponding to the second low pass filter, or switching the second low pass filter to the first low pass filter when the frequency of the second track-crossing signal continues to be lower than the critical frequency corresponding to the first low pass filter, otherwise continuing using the second low pass filter; and
continuing using the third low pass filter when the filter being used is the third low pass filter and the frequency of the second track-crossing signal is higher than the critical frequency corresponding to the second low pass filter, or switching the third low pass filter to the second low pass filter when the frequency of the second track-crossing signal continues to be lower than the critical frequency corresponding to the second low pass filter.

9. The bandwidth control method of claim 8, wherein a bandwidth of the third low pass filter is wider than a bandwidth of the second low pass filter, and the bandwidth of the second low pass filter is wider than a bandwidth of the first low pass filter.

10. The bandwidth control method of claim 8, wherein the step for calculating the frequency of the second track-crossing signal comprise:
providing a pulse signal with a predetermined period; and
calculating number of the second track-crossing signals within one period of the pulse signal so as to determine the frequency of the second track-crossing signal.
